(19) United States
(12) Patent Application Publication
(10) Pub. No.: US 2012/0129396 A1
(43) Pub. Date: May 24, 2012

(54) PLUG CONNECTOR HAVING MULTIPLE CIRCUIT BOARDS AND METHOD OF MAKING THE SAME

(75) Inventors: CHIEN-CHIUNG WANG, New Taipei (TW); QING-MAN ZHU, Kunshan (CN); XUE-LIANG ZHANG, Kunshan (CN); JIANG-HONG WU, Kunshan (CN)

(73) Assignee: HON HAI PRECISION INDUSTRY CO., LTD., New Taipei (TW)

(21) Appl. No.: 13/302,148

(22) Filed: Nov. 22, 2011

(30) Foreign Application Priority Data
Nov. 22, 2010 (CN) 201010553003.X

(51) Int. Cl. H01R 13/648; H01R 13/66; H01R 43/20; H01R 24/00

(52) U.S. Cl. 439/607.01; 439/676; 439/620.24; 29/876

(57) ABSTRACT

A plug connector (1000) comprises a shielding cover (6) and a circuit board module (100) mounted therein. The circuit board module includes a first circuit board (1) having a rear soldering portion (15) for soldering a cable, a second circuit board (2) having a number of mating pads (211, 212, 203, 204, 205) for mating with a receptacle and a number of soldering pads (213) for connecting to a top surface (10) of the first circuit board, and a third circuit board (3) having a number of mating pads (311, 312, 303, 304, 305) for mating with the receptacle and a number of soldering pads (313) for connecting to a bottom surface (11) of the first circuit board.

### BACKGROUNDING OF THE INVENTION

1. Field of the Invention

The present invention relates to a plug connector, and more particularly to a SFP (Small Form factor Pluggable) connector having multi-board.

2. Description of Related Art

In communication applications, a cable end plug connector having two or more printed circuit boards for transmitting high rate signals is widely used. U.S. Pat. No. 7,883,341 issued to Lang on Feb. 8, 2011, discloses a plug connector for mating with a receptacle. The plug connector comprises an upper circuit board and a lower circuit board respectively connecting to a cable. The upper circuit board has a number of first soldering pads formed at the rear portion of the top surface and a number of second soldering pads formed at the rear portion of the bottom surface. The lower circuit board has a number of third soldering pads formed at the rear portion of the top surface and a number of fourth soldering pads formed at the rear portion of the bottom surface. The cable is soldered to the first through fourth soldering pads on the two circuit boards via soldering material. The upper circuit board and lower circuit board are separated from each other at a certain distance to avoid shorting between the soldering material at the second soldering pads and the soldering material at the third soldering pads. It is hard to reduce the height of the connector.

Hence, a plug connector having an improved structure of the multi-board is desired.

### SUMMARY OF THE INVENTION

Accordingly, an object of the present invention is to provide a plug connector. The plug connector adapted for mating with a receptacle having a number of contacts. The plug connector comprises a shielding cover and a circuit board module mounted therein. The circuit board module comprising a first circuit board, a second circuit board and a third circuit board. The first circuit board has a rear soldering portion for soldering the cable, a top surface, a bottom surface and a plurality of mounting pads formed at both front portions of the top surface and bottom surface. The second circuit board has a plurality of mating pads formed at a front portion thereof for mating with the contacts and a plurality of soldering pads formed at a rear portion thereof for connecting to the mounting pads on the top surface of the first circuit board. The third circuit board has a plurality of mating pads formed at a front portion thereof for mating with the contacts and a plurality of soldering pads formed at a rear portion thereof for connecting to the mounting pads on the bottom surface of the first circuit board. The cable is soldered to the top surface and bottom surface of one circuit board. The height of the plug connector could be reduced.

Other objects, advantages and novel features of the invention will become more apparent from the following detailed description when taken in conjunction with the accompanying drawings.

### BRIEF DESCRIPTION OF THE DRAWINGS

FIG. 1 is an assembled perspective view showing a plug connector of the present invention;

FIG. 2 is a partially exploded perspective view showing the plug connector as shown in FIG. 1;

FIG. 3 is a partially exploded perspective view showing the plug connector as shown in FIG. 2;

FIG. 4 is an exploded perspective view showing the plug connector as shown in FIG. 1;

FIG. 5 is an assembled perspective view showing the circuit board module as shown in FIG. 3;

FIG. 6 is a view similar to FIG. 5, taken from another aspect;

FIG. 7 is a top view showing the first circuit board as shown in FIG. 5;

FIG. 8 is a bottom view showing the first circuit board as shown in FIG. 7;

FIG. 9 is a top view showing the second circuit board as shown in FIG. 5;

FIG. 10 is a bottom view showing the second circuit board as shown in FIG. 9;

FIG. 11 is a top view showing the third circuit board as shown in FIG. 5; and

FIG. 12 is a bottom view showing the second circuit board as shown in FIG. 11.

### DETAILED DESCRIPTION OF THE PREFERRED EMBODIMENT

Reference will now be made in detail to the preferred embodiment of the present invention.

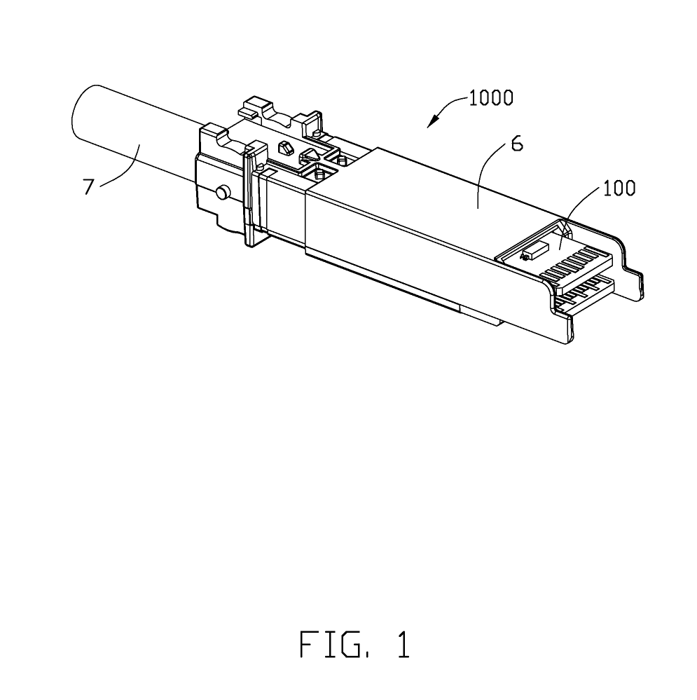

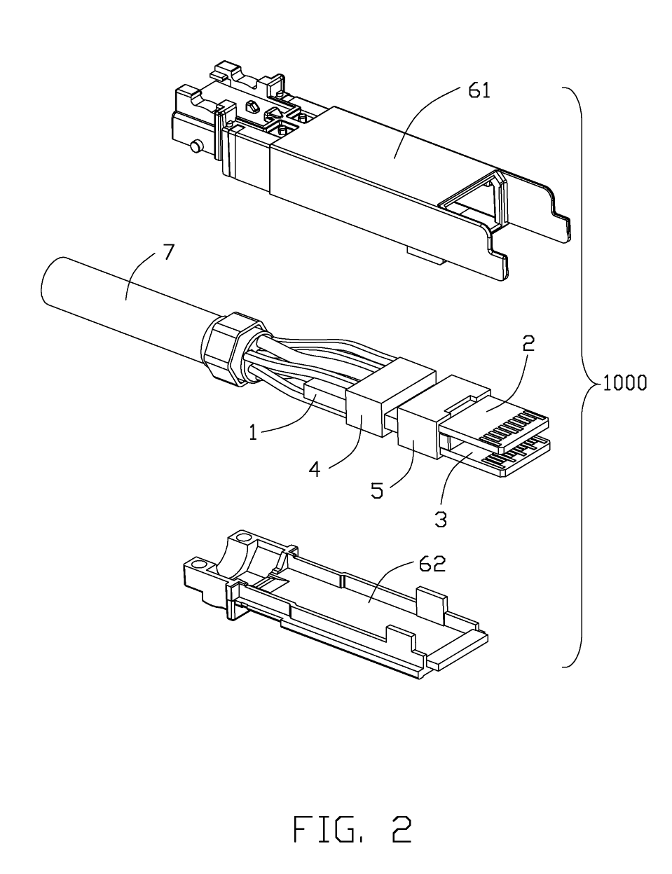

Referring to FIGS. 1 and 2, a plug connector 1000 includes a shielding cover 6 and a circuit board module 100 mounted in the shielding cover 6. The shielding cover 6 includes a top cover 61 and a bottom cover 62 mounted to the top cover 61 for defining a cavity to receive the circuit board module 100.

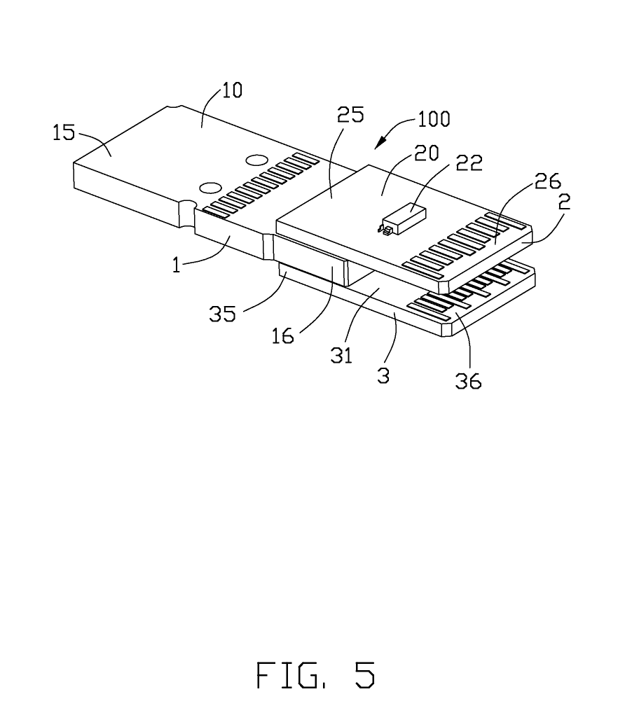

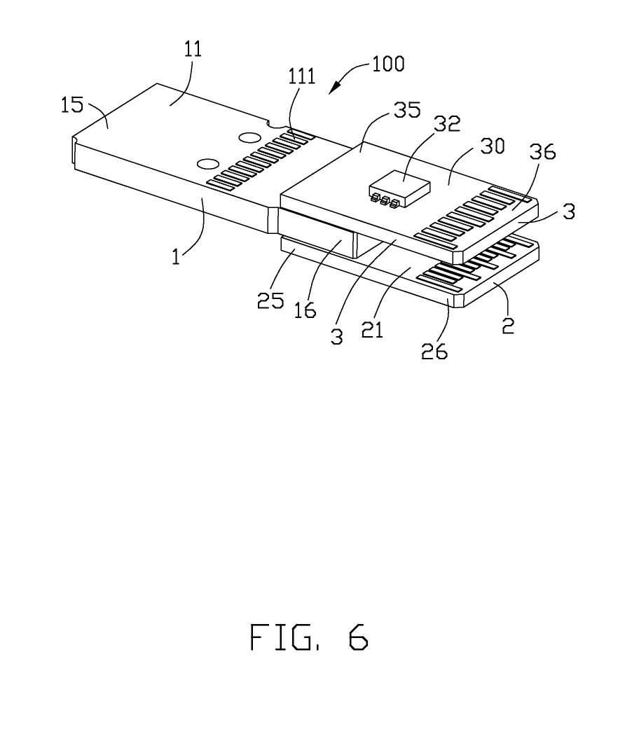

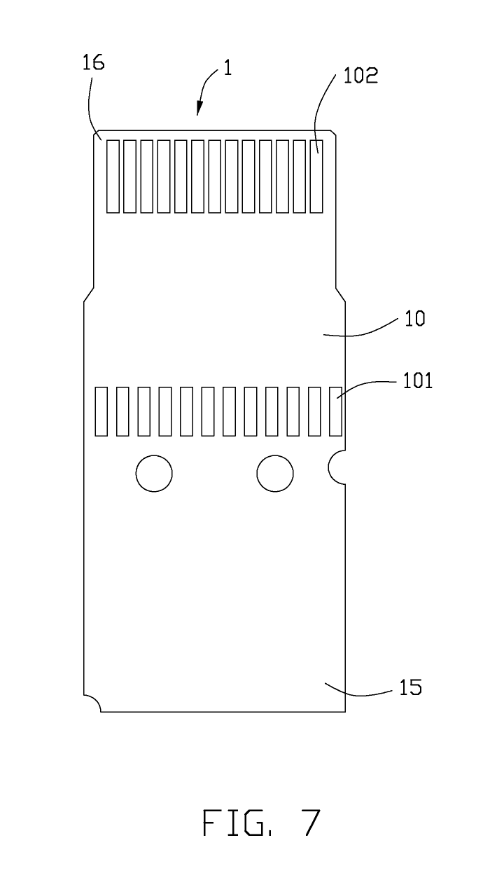

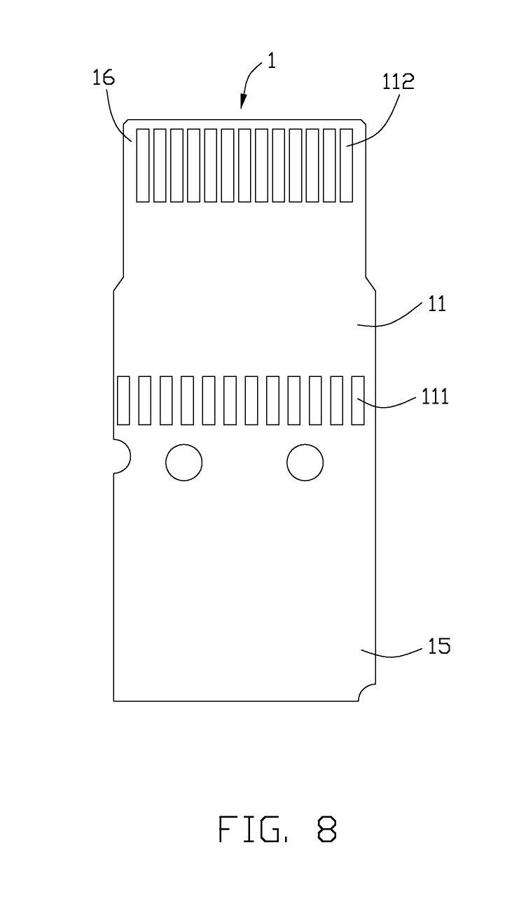

Referring to FIGS. 5 to 8, the circuit board module 100 comprises a first circuit board 1 having a rear soldering portion 15 for soldering with a cable 7, a top surface 10, a bottom surface 11, a plurality of mounting pads 102, 112 formed at a front portion 16 of both the top surface 10 and the bottom surface 11, and a plurality of cable soldering pads 101, 111 formed at the rear soldering portion 15 for soldering with the cable 7. The cable soldering pads 101, 111 are respectively electrically connected to the mounting pads 102, 112 through a number of circuits (not shown) in the first circuit board 1.

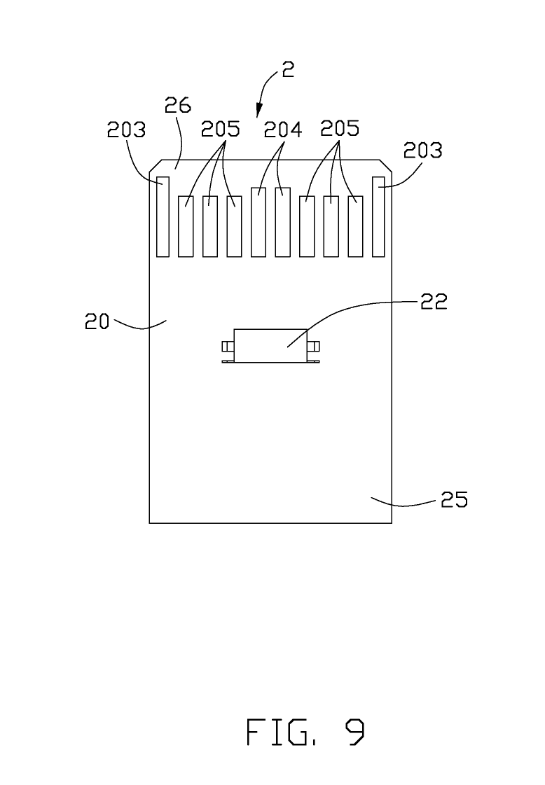

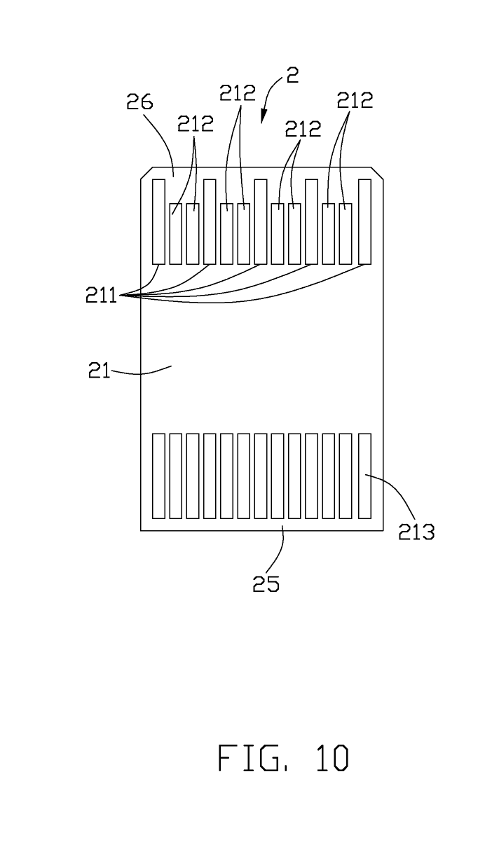

Referring to FIGS. 5 to 10, the circuit board module 100 further comprises a second circuit board 2 having a top surface 20, a bottom surface 21, a front mating portion 26 and a rear connecting portion 25. The second circuit board 2 has a plurality of mating pads 211, 212 formed on the bottom surface 21 of the front mating portion 26 for mating with the contacts of a receptacle connector (not shown) and a plurality of soldering pads 213 formed on the bottom surface 21 for connecting with the mounting pads 102 on the top surface 10 of the first circuit board 1. The second circuit board 2 further comprises a plurality of mating pads 203, 204, 205 formed on the top surface 20 of the front mating portion 26 for mating with the contacts of a receptacle connector (not shown) and at least one chip 22 mounted on the top surface 20.

The mating pads 211, 212 include a plurality of first grounding pads 211 and a plurality of signal pads 212. The first grounding pads 211 extend beyond the signal pads 212 along the mating direction for grounding, and a pair of signal pads 212 formed between two first grounding pads 211 for transmitting differential signals.

The mating pads 203, 204, 205 include a plurality of second grounding pads 203, a plurality of power pads 204 and a plurality of control pads 205. The second grounding pads 203 extend beyond the power pads 204 along the mating direction and the power pads 204 further extend beyond the control pads 205 along the mating direction. The second grounding pads 203 contact the grounding before the power pads 204 providing a power to the chip 22. A pair of power pads 204 are formed at the middle of two second grounding pads 203, and a number of control pads 205 are formed between a second grounding pad 203 and a power pad 204 for transmitting control signals to the chip 22.

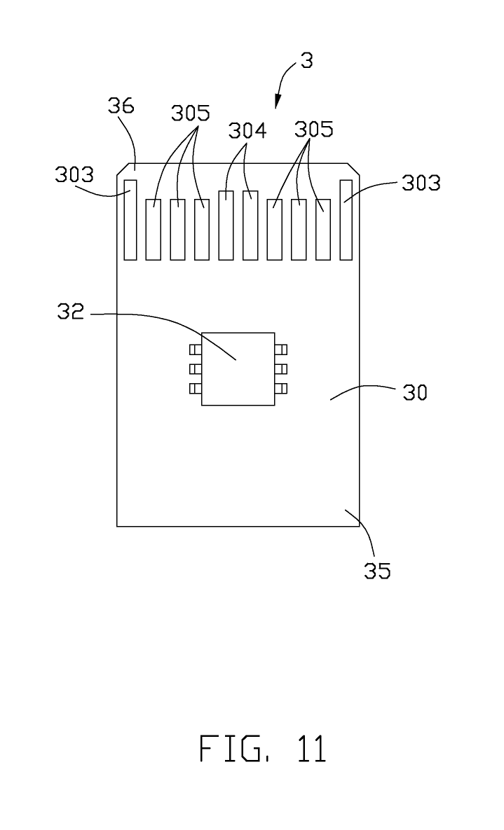

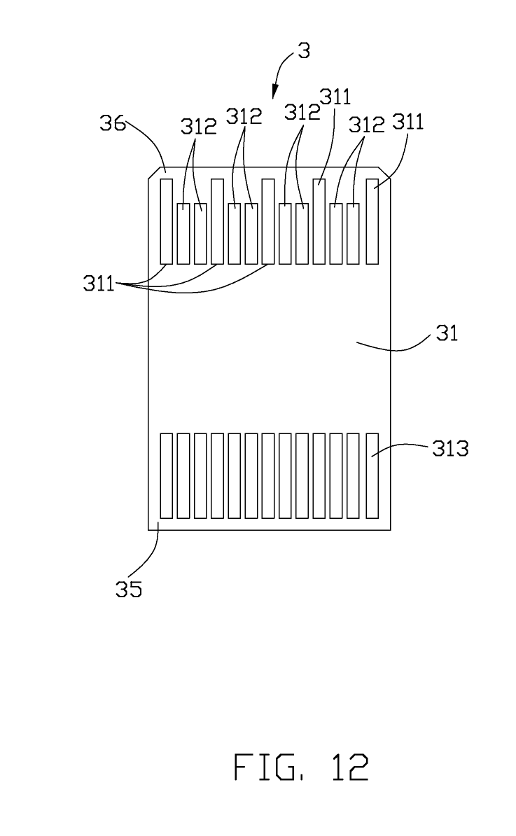

Referring to FIGS. 5 to 12, the circuit board module 100 further comprises a third circuit board 3 having a top surface 31, a bottom surface 30, a front mating portion 36 and a rear connecting portion 35. The third circuit board 3 has a plurality of mating pads 311, 312 formed on the top surface 31 of the front mating portion 36 for mating with the contacts of a receptacle connector and a plurality of soldering pads 313 formed on the top surface 31 for connecting with the mounting pads 112 on the bottom surface 11 of the first circuit board 1. The third circuit board 3 further comprises a plurality of mating pads 303, 304, 305 formed on the bottom surface 30 of the front mating portion 36 for mating with the contacts of a receptacle connector and at least one chip 22 mounted on the bottom surface 30.

The mating pads 311, 312 include a plurality of first grounding pads 311 and a plurality of signal pads 312. The first grounding pads 311 extend beyond the signal pads 312 along the mating direction for grounding, and a pair of signal pads 312 formed between two first grounding pads 311 for transmitting differential signals.

The mating pads 303, 304, 305 include a plurality of second grounding pads 303, a plurality of power pads 304 and a plurality of control pads 305. The second grounding pads 303 extend beyond the power pads 304 along the mating direction, and the power pads 304 further extend beyond the control pads 305 along the mating direction. The second grounding pads 303 contact the grounding before the power pads 304 providing power to the chip 32. A pair of power pads 304 are formed at the middle of two second grounding pads 303, and a number of control pads 305 are formed between a second grounding pad 303 and a power pad 304 for transmitting control signals to the chip 22.

A pair of differential signals are transmitted through a pair of the signal pads 212 on the bottom surface 21 of the second circuit board 2, and then transmitted through the mounting pads 102 of the first circuit board 1 to the cable 7. Another pair of differential signals are transmitted through a pair of the signal pads 312 on the top surface 31 of the third circuit board 3, and then transmitted through the mounting pads 112 of the first circuit board 1 to the cable 7.

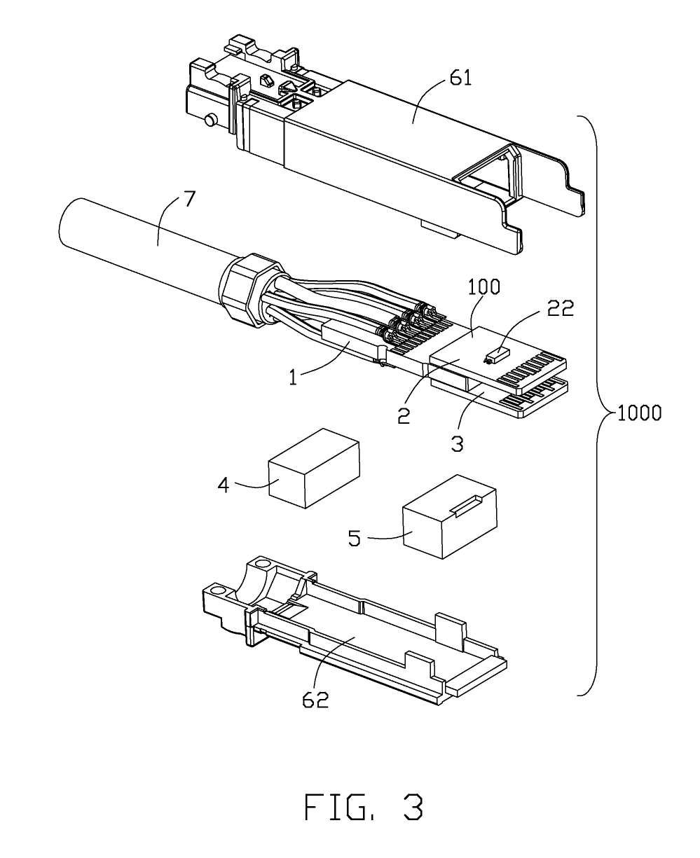

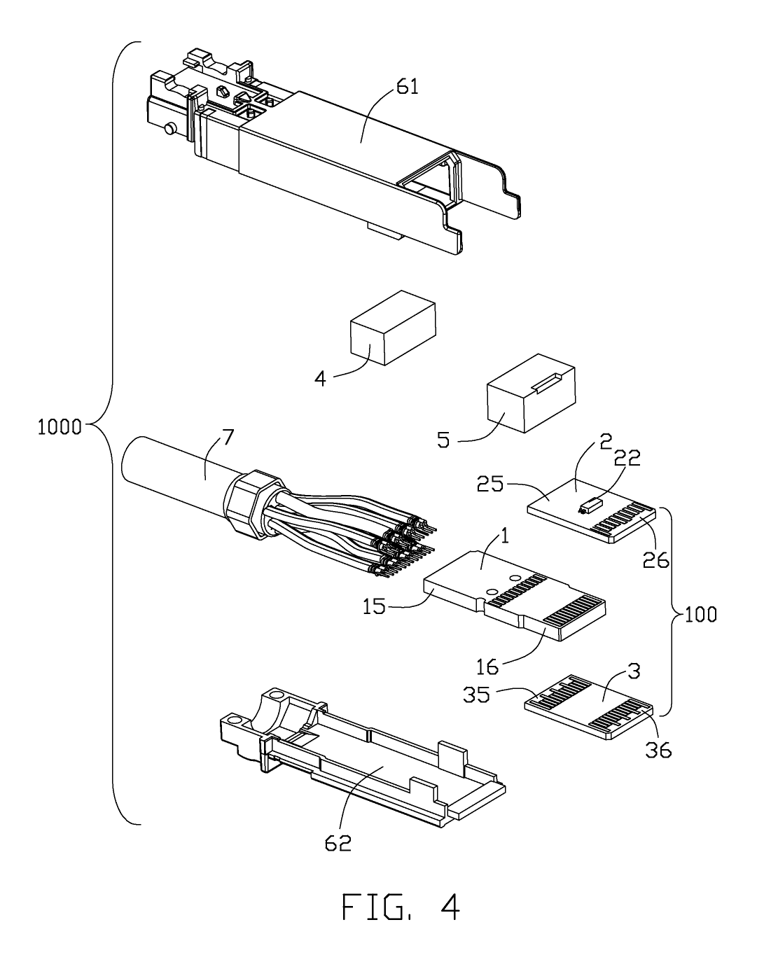

Referring to FIGS. 3 and 4, the cable 7 is soldered to the rear soldering portion 15 of the first circuit board 1 at a soldering section. The plug connector 1000 further includes an insulative block 4 mounted around the soldering section for protecting the soldering section. The first circuit board 1, the second circuit board 2 and the third circuit board 3 are surface mounted together at a coupling section. The circuit board module 100 includes a plastic block 5 mounted around the coupling section for protecting the coupling section. The circuit board module 100 has an improved structure and reduced height.

It is to be understood that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A plug connector adapted for mating with a receptacle having a number of contacts, comprising:
a shielding cover; and
a circuit board module mounted in the shielding cover and comprising:
a first circuit board having a rear soldering portion for soldering with a cable, a top surface, a bottom surface and a plurality of mounting pads formed at both front portions of the top surface and the bottom surface;
a second circuit board having a plurality of mating pads formed at a front portion thereof for mating with the contacts and a plurality of soldering pads formed at a rear portion thereof and connected to the mounting pads on the top surface of the first circuit board; and
a third circuit board having a plurality of mating pads formed at a front portion thereof for mating with the contacts and a plurality of soldering pads formed at a rear portion thereof and connected to the mounting pads on the bottom surface of the first circuit board.

2. The plug connector as claimed in claim 1, wherein said mating pads include: a plurality of first grounding pads and a plurality of signal pads formed, respectively, on a bottom surface of the second circuit board and on a top surface of the third circuit board; and a plurality of second grounding pads, a plurality of control pads, and a plurality of power pads formed, respectively, on a top surface of the second circuit board and on a bottom surface of the third circuit board, said first grounding pads extending beyond the signal pads along the mating direction, said second grounding pads extending beyond the power pads along the mating direction, the power pads extending beyond the control pads along the mating direction.

3. The plug connector as claimed in claim 2, wherein said circuit board module further includes a pair of chips respectively mounted on the top surface of the second circuit board and the bottom surface of the third circuit board, said power pads providing power to the chip, said control pads transmitting control signals from the chip to the receptacle.

4. The plug connector as claimed in claim 1, wherein said second circuit board and third circuit board are surface mounted to the first circuit board.

5. The plug connector as claimed in claim 4, further comprising an insulation material around a connected section between the first circuit board, the second circuit board, and the third circuit board.

6. The plug connector as claimed in claim 1, wherein the cable is soldered on a soldering portion of the first circuit board to define a soldering section, the plug connector further including an insulation material around the soldering section for protecting the soldering section.

7. A method of manufacturing a plug connector for mating with a receptacle having a number of contacts, comprising the steps of:
providing a first circuit board having a rear soldering portion for soldering a cable, said first circuit board having a top surface, a bottom surface and a plurality of mounting pads formed at both front portions of the top surface and bottom surface;
providing a second circuit board having a plurality of mating pads formed at a front portion thereof for mating with the contacts and a plurality of soldering pads formed at a rear portion thereof for connecting to the mounting pads on the top surface of the first circuit board;
providing a third circuit board having a plurality of mating pads formed at a front portion thereof for mating with the contacts and a plurality of soldering pads formed at a rear portion thereof for connecting to the mounting pads on the bottom surface of the first circuit board;
soldering the soldering pads of the second and third circuit boards to the mounting pads to define a coupling section on the first circuit board;
providing a cable having a plurality of wires and soldering the wires to the rear soldering portion of the first circuit board to form a soldering section;
providing a shielding cover defining a cavity for receiving the first, second and third circuit boards.

8. The method of manufacturing a plug connector as claimed in claim 7, wherein said soldering pads of the second and third circuit board are surface mounted to the mounting pads on the first circuit board.

9. The method of manufacturing a plug connector as claimed in claim 7, further including a step of supplying an insulation material around the coupling section.

10. The method of manufacturing a plug connector as claimed in claim 7, further including a step of supplying an insulation material around the soldering section.

11. A cable assembly comprising:
a pair of first printed circuit boards spaced from each other in a parallel relation in a first direction, each of said first printed circuit boards defining a front mating region and a rear mounting region in a second direction perpendicular to said first direction; and
a second printed circuit board positioned between the pair of first printed circuit boards with along the second direction a front connecting section connected around the rear mounting regions of said pair of first printed circuit boards, and a rear connecting section connected with a plurality of wires which extend rearward in said second direction; wherein
a distance between said pair of first printed circuit boards is larger than a thickness of each said first printed circuit board.

12. The cable connector assembly as claimed in claim 11, wherein the second printed circuit board is dimensioned similar to said distance.

13. The cable connector assembly as claimed in claim 12, wherein the front connecting section of the second printed circuit board is mechanically and electrically connected to the rear mounting region of the first printed circuit board.

14. The cable connector assembly as claimed in claim 11, wherein each of said first printed circuit boards is equipped with a chip.

15. The cable connector assembly as claimed in claim 11, wherein an insulative block circumferentially encloses the rear mounting regions of the pair of first printed circuit boards and a front connecting section of the second printed circuit board.

16. The cable connector assembly as claimed in claim 15, further including another insulative block to circumferentially enclose the rear connecting section of the second printed circuit board and front end sections of the wires.

17. The cable connector assembly as claimed in claim 16, wherein a pair of covers commonly sandwich the pair of first printed circuit boards, the second printed circuit board, front portions of the wires and both said insulative blocks.
